(19) United States
(12) Patent Application Publication
(10) Pub. No.: US 2022/0150214 A1
(43) Pub. Date: May 12, 2022

(54) SYSTEM AND METHOD FOR ESTABLISHING A RESIDENTIAL PROPERTIES WEB-BASED NETWORK

(71) Applicant: Homepage Corporation, Waterloo (CA)

(72) Inventor: Otman Adam Basir, Waterloo (CA)

(21) Appl. No.: 17/500,870

(22) Filed: Oct. 13, 2021

Related U.S. Application Data
(60) Provisional application No. 63/091,095, filed on Oct. 13, 2020.

(51) Int. Cl. H04L 101/69; H04L 61/4511; G06F 16/958

(52) U.S. Cl. CPC H04L 61/609; G06F 16/958; H04L 61/1511

(57) ABSTRACT

A geographic-locations based network for residential properties enables residential-property centric connectivity among the inhabitants of the properties, and between them and government organizations, retailers, and service providers, and enables efficient digital content transportation and distribution to the inhabitants of such properties. The system provides another layer of networking that is residential-property address-based and location based that can facilitate seamless and timely content distribution and interaction between residential-property inhabitants and between them and other organizations.

### BACKGROUND

The present disclosure is related to the field of Internet of Things. A residential-properties location based network is established to facilitate bi-directional communication and interaction between the inhabitants of residential properties; and between them and government agencies, service providers, and retailers.

The internet is a well-established network that connects people and organizations, government and private, through a wide range of technologies. In addition to using telephony, an individual or an organization can establish connectivity with others by plugging their device(s) wirelessly or in a wired manner to the internet. This connectivity allows individuals allows individuals to socialize and share digital content with others. It also allows an organization to communicate with other organizations and individuals and to conducts their business effectively. The internet uses the Internet Protocol address (IP address) as a unique addressing regime to identify devices connected to it. These addresses are used to facilitate end-to-end content transportation. Typically, an individual that is connected to the internet has a unique IP address at any point in time, whether static or dynamic. An organization has as many IP addresses as the number of devices it has connected to the internet. Connectivity is typically established to the internet via modems. Typically, a router is used to connect multiple devices together and to the internet via a modem.

Existing internet protocols, however, lack precise location context and lack effective ways to enable location-based shared connectivity. For example, take the case of a property related message to be delivered from the city-hall to the inhabitants of a property in the city. The city can either deliver this message to the household of the property by mailing the message using postal or special delivery service, or digitally by emailing it or texting it to an individual that they associate with the property, for whom the city would presumably have an email address or phone number. The mail option could take days to be arrive at the property, and even once delivered, there is the possibility that none of the inhabitants is at the property to receive it and/or deal with it. If it was communicated via email or as text message, the individual will typically receive it through a device connected to the internet, that could be at any arbitrary location. This puts the burden on the individual who received the message to share the message with the relevant inhabitants of the property, either in person, by phone, or other communications means. Furthermore, the recipient could be such that he or she could not timely share the message with the relevant property inhabitants. There is also the possibility that the email address and/or the phone number they have for the individual in their records is outdated. This applies to many other types of property centric content transportation and distribution, including, commercial flyers, utility bills, profession services ads and promotions, etc. Furthermore, existing tools fail to separate the residential-property related digital information, such as bills, expenses, taxes, contracts, and communications, from the personal information of the person who receives them through their personal emails or other personal communication means.

As another case, take the example of a school administration that wishes to inform certain people who live in a certain geographical area that they discovered a COVID19 case at the school. The only ways for them to achieve this is either by calling every household, or sending messages (text or email) to contacts they have on file, or by using media broadcasting means, or a combination of. For similar reasons mentioned above, none of these means are reliable. Furthermore, some means can be quite expensive and/or tedious to perform.

Another case, take the example of a neighbor who wants to communicate a neighboring household. In today's era, it is quite seldom that neighbors share contact information, such as phone numbers and emails. Physical interaction has become a rare event. Furthermore, it is quite often that such intent to communicate is in the context of neighbor to neighbor, and not a specific individual to a specific individual. For instance, a neighbor who wishes to inform their neighbor that they left their garage door open has no specific person of the household in mind, as long as the message gets to the household. Knocking on the door of the neighbor, as inconvenient and as hard sometimes as it can be, quite often, this option tends to be the only option.

Therefore, there is a critical need for techniques that overcome the above-mentioned disadvantages and limitations.

### SUMMARY

A disclosed embodiment provides methods for establishing Geographic-Locations Based Network for residential properties, enabling residential-property centric connectivity among the inhabitants of the properties, and between them and government organizations, retailers, and service providers, and enabling efficient digital content transportation and distribution to the inhabitants of such properties. The system responds to a critical need for establishing another layer of networking that is residential-property address-based and location based that can facilitate seamless and timely content distribution and interaction between residential-property inhabitants and between them and other organizations.

A disclosed embodiment provides a method for collecting and combining, assembling and storing relevant information about each residential property in a given region, city, or country. This information includes the property address attributes, financial profile of the property, the inhabitants of the property, market value, geographic area of the property, as well as their demographic profiles on the neighborhood of the property, its current and previous owners, etc. Information about the properties is stored in a database (Residential-Properties Database of the Network). Information about each property is extracted from a number of sources, including as examples, Real-Estate Properties Registry and Recorder Of Deed, Census Database, Street-View Images, Open City Data Platforms and Databases.

The Residential-Properties Database is searched to retrieve such information about any residential property, or a neighborhood of residential properties. The search method is constructed such that it can search for properties using various combinations of the property attributes. For example, the geographic area of the property, property street address, financial, and demographic profiles.

A website for each residential property is automatically created, stored, and hosted, populating it with information extracted from the Residential-Properties Database about the property, creating and assigning to it a unique domain-name address that facilitates efficient location-based coupling between any property and its entry in the Residential-Properties Database. Furthermore, the website is automatically populated with actionable functions that a user can click on to perform various tasks, for example, such as socializing with neighbors, access and browse digital content that was intended for distribution to the inhabitants of the property, or to advertise residential-property opportunities for professionals to bid on (e.g., plumbing repair, lawn-mowing, and/or painting tasks).

The Residential-Properties Database can be efficiently searched for the website of a particular property based on its street address (or its known Latitude-Longitude location), searching for the websites of all properties that fall within a ZIP code area, searching for the websites of all properties that fall within a particular geographic area(s), and searching for the website of all properties that neighbor a particular landmark (natural and/or manmade), or searching for properties that match certain demographic and/or financial characteristics.

A claim made by a person for the purpose of obtaining control of the property website is first verified. The verification method implements various options for a person to prove affiliation to a property, that is a property inhabitant and/or owner who should be granted control of the property website, i.e., a property-affiliated user.

The first proven affiliated user assumes the super-user status of the property website. Furthermore, the affiliated super-user is enabled to add other persons as affiliated users to the property website and to grant them access to the different components of the property website, such as digital contents (e.g., flyers, mailboxes, etc.), and website functions (e.g., chatroom functions, chatting with neighbors functions, RFP posting functions, etc.)

A property Pooled-Funds Account is enabled to be set up. The super-user can use this method to specify the amount (in actual monetary amounts or percentage) each affiliated user should contribute to this pooled-funds account, and the frequency at which funds should be transferred from a contributor's bank or credit account(s) to the Pooled-Funds Account.

A property inhabitant who is verified as an affiliated user is enabled to identify the particular properties in the vicinity of his/her property that he/she considers neighbors. The method provides an option for automatically identifying these neighboring properties based on street addresses, zip codes, geographical area considerations and the type of the property. The method further provides a map of the area around the property and allows the affiliated user to invite the households of neighboring properties to become neighbors. The method further provides a function that allows the affiliated users of a property who were to become neighbors of a neighboring property to either accept or reject the invitation to become neighbor of the property. The method provides the inviting property to share with the invitees a profile of the inviting property's household using text, pictures, images, videos, and audio content.

An affiliated user of a given property is enabled to create and manage a neighbors chatroom. The chatroom function allows multiple neighbors to exchange, in real-time, text and rich media contents, such as images, videos, and audio content.

A property-affiliated user is enabled to conduct offline and online chatting with the affiliated users of the properties in his or her list of neighbors.

In many location relevant applications, the location of the user is inferred as the location of the device the user is using to interact with the application. Take as an example, a user using a search engine on his/her device to search for a place of interest or to search for particular goods to buy. In such example, the search engine would use the Longitude-Latitude location of the device or its IP address to deduce the user location. On one hand, the location of the device location may not be particularly relevant to what the user is searching for. The user could be at work but wishing to look for a restaurant in the vicinity of his or her home. Thus, the search results, quite often, are proven to be irrelevant. On the other hand, when the IP of the device is used to infer the location of the user, the computed location often lacks the accuracy required for facilitating location-based services. One embodiment provides a method for overriding the computed device position with a position that is specified by either an application automatically, or by the user manually. For example, automatically specifying the position can be based on the application context, where the user contextual location is inferred as either the current device location computed using the device GPS (or using other positioning means), or the location of the residential property the user is an inhabitant of. Thus, applications the user executes on his/her device, that have the residential property they are affiliated with as a location context, are provided the location or address of the property as the intended location. Other types of applications are implicitly provided the device computed position as the intended location. Furthermore, the user can cause the device to switch between the two modes manually, for example by pressing or activating a “from-home” function to imply the property address or its longitude-latitude location as the intended location, or choose to enter a different position manually. Furthermore, in the case of property relevant applications, the method provides three residential-property location sub-contexts: property street address location, property zip code location, and geographic area location. Depending on the type of application the affiliated user executes on the device while it is in the residential-location context, the appropriate location sub-context will be implied.

The present disclosure also provides a method for interfacing the Residential-Properties Network to government agencies, landlords, retailers, utility companies, and services providers and contractors. The method facilitates the transportation and distribution of digital content such as alerts, notifications, flyers, messages, bills, invoices, proposals, etc. The method enables a digital content source to specify the digital content in various format (text, audio, images, and video, or a combination of), specify target residential properties, and rules for the distribution of the content. For example, the method allows the source of the digital content that is intended for distribution to prescribe a specific list of properties, properties that fall within certain zip code areas, or properties within certain geographical areas as distribution targets. Furthermore, the source can prescribe frequency of distribution, time of the day, day of the week, or day of the month at which the content should be distributed. Furthermore, the method compiles statistical data on whether the delivered content was read, which parts of the content had more frequent reads, time of access and the length of time the property inhabitants spent in reading and/or browsing the content.

The system also connects the website to residential apparatuses such as sensors, actuators and appliances that are installed at the property. Affiliated users are able to monitor and operate these apparatuses through the property website, manually, or automatically, taking advantage of interfacing protocols provided by the original apparatuses manufactures. Furthermore, the method enables the user to set up operation modes of the apparatuses based on the relative location of the user and the property location. For example, the operation of a garage door is performed such that the garage door closes as soon as the user leaves the property by comparing the location of the user, inferred form a device the user is carrying, with the property location. Or open the garage door when the method detects that the user is approaching the property. Similarly, various economical, security and safety rules can be setup to regulate the operation of devices installed at the property. The method allows the user to setup rules for controlling these devices. The method uses communication protocols such as MQTT to interact with the devices in a secure manner.

The inhabitants' personal digital information is separated from the digital information that is specific to the property they inhabit. The method provides for a function to enable information sharing among the affiliated inhabitants in accordance with access and sharing rules defined by the property affiliated super-user. The method provides a dashboard for displaying summaries of the information. For example, the dashboard displays monthly phone expenses, hydro expenses, rent expenses, maintenance expenses, etc. The method parses the content to extract relevant information to be displayed on the dashboard.

The method provides a method for archiving transferable property related content, such as important contracts, warranties, designs, plans (architectural, electrical, mechanical, etc.).

The system provides for a method for managing the transfer of a property website to new affiliated users (e.g., new property owners, new tenants, etc.). The method facilitates the removal of the information created by the prior affiliated inhabitants of the property, or information they have received and stored in the website of the property. The method enables the transfer and storage of this information to an electronic storage medium for future access and use by the prior affiliated inhabitants. The method enables the transfer of existing property related information, such as important contracts, warranties, designs, plans (architectural, electrical, mechanical, etc.), to the new inhabitants.

The residence entity may contain digital content that is relevant for the new owner: warranty documents, plans, service contracts, manuals, instructions, FYI kind of information, etc. The sales transaction will trigger a transfer of the homepage entity to the new owner (or new tenant) and all information the prior owner stored in the transferable data folder.

The system takes advantage of the implicit residential context of the application to parse through electronic bills and invoices received through the network and categorizes them into various property related areas of expense. These expenses are presented to the users on a dashboard. Furthermore, the method provides for a setup the property-affiliated users can execute to set rules for settling bills and invoices from the Property Pooled-Funds Account. The method, furthermore, enables the users to pay for expenses from such account.

The disclosed method allows the residents of a property to advertise on the property website articles they wish to sell. The resident can use the website to show a textual description on the articles, images of the articles, or videos on the articles. Since the property website has a location context, the method further enables the matching of the articles with searches for used articles based on location considerations. For example, a person looking to buy a used sofa will be presented with sofas advertised by the residential properties in his or her vicinity. The locations of the searcher and the articles are inferred from the addresses associated with their respective property website.

### BRIEF DESCRIPTION OF THE DRAWINGS

FIG. 1 is a schematic of one implementation of a residential properties web-based network.

FIG. 2 is a schematic showing a user affiliated with a residential property interacting with the property website.

FIG. 3 illustrates a device executing a residential-property application switching between a device-location mode and a residential-property mode.

FIG. 4 illustrates three positioning sub-contexts to which the device has access.

FIG. 5 illustrates an example of Residential-Properties Network Database constructed from information extracted from existing databases.

FIG. 6 is a flowchart illustrating the creation of a website for a given residential property.

FIG. 7 illustrates the steps for performing property website claimer affiliation verification.

FIG. 8 illustrates the steps for verifying the affiliation of a claimer to a residential-property website using a combination of code mailed to the property and another electronically communicated to the claimer.

FIG. 9 illustrates the steps for verifying the affiliation of a claimer to a residential-property website using identification information of internet connected devices installed at the property.

FIG. 10 illustrates an example of internet devices installed at the property that can be used in the affiliation verification process.

FIG. 11 illustrates example steps for verifying the affiliation of a claimer to a property website using utility bills and/or contracts.

FIG. 12 illustrates example steps for enabling a property affiliated user to setup a neighborhood.

FIG. 13 illustrates example steps for distributing digital content such as alerts, notifications, and news based on rules specified by the source, including target locations.

FIG. 14 illustrates the steps for generating access and use reports to be shared with content sources.

FIG. 15 illustrates an example of distributing digital flyers to particular households based on location and other rules specified by the source of the flyers.

FIG. 16 illustrates an example of police digital alerts distribution to targeted residential properties.

FIG. 17 illustrates an example of school digital alerts distribution to targeted residential properties.

FIG. 18 illustrates an example of a virtual property mailbox, and the steps for delivering digital mail targeted to the virtual-mailbox of the real-state property.

FIG. 19 illustrates a method for sorting and paying for bills and a dashboard to display to the user a detailed financial integrated report on payables and up-to-date expenses.

FIG. 20 illustrates the steps of settling payables and for setting up a pooled Funds account for the users affiliated users.

FIG. 21 illustrates the steps for an affiliated property user to advertise, on the property website, request for bid to perform work at the property.

FIG. 22 is a flowchart of the method for selling items over the network.

FIG. 23 is an example screenshot for the sale function of FIG. 22.

### DETAILED DESCRIPTION

Hypergraphs, matrices, tables, lists and hypergraph attributes are used to represent residential properties as network of entities, the spatial relations between them, their locations at various scales, including street address location, longitude-latitude location, zip code location, geographic area location, and the vicinity to landmarks. Furthermore, it models the inhabitants of these properties and the relations among these inhabitants, as well as their financial and demographic profiles. Each residential property can be represented as a node adjoining other nodes. Joining nodes of the hypergraph can be based on spatial considerations, or considerations with respect to social relations among their inhabitants. Thus, the adjoining of two nodes signify the fact that the inhabitants of the corresponding residential properties can interact with each other, regardless of their individual or personal identities, as long as they are inhabitants of the properties. They interact with each other without using their personal communication applications such as social-media apps. Furthermore, they can interact with each other without needing third party brokers.

A characteristic of the residential-properties network is that the inhabitants of a residential property can interact, collectively, with other people, governments, retailers, service providers, and digital content providers under a unified abstract entity.

Another characteristic of the residential-properties network is that such interaction is facilitated through a common user web-based interface that is residence centric. As such, this interface has an implicit invariant geographical location, albeit, street address, zip code, etc. This allows content delivery to target content consumers through such location-based interface. Furthermore, it allows transact on various dealings with the residential property's location as an implicit location.

Another characteristic of the residential-properties network is that financial and demographic profiles of geographical regions and neighborhoods can be inferenced by employing the network topology and node attributes. One ground for such inferencing is that residents of properties of similar property market values tend to be of similar financial means. Another ground is that the market value of a residential property can be used to inference the financial means of its residents. The property size in conjunction with its location can be used to inference household size and financial means. Such inferencing can be aggregated on a neighborhood, street, or regional bases. Such inferenced knowledge can be linked to location attributes of the properties and implicitly to their inhabitants. This enables the optimization and facilitation of digital content based on geographical, financial and demographic profile considerations. For example, a retailer can query the network to determine those properties in a city that meet certain financial profile attributes and use the network to inform the residents of these properties of a sale event.

Another characteristic is that the interaction between the network nodes and other entities on one hand, and between the property residents and the digital content decimated through the network on the other hand, is measurable and quantifiable. Furthermore, it has an implicit usage and invariant location context. For example, a retailer who uses the network to disseminate flyers to the target residents, can query the network to deduce the level of interaction their flyers received and hence can determine interest levels of the targeted residents in the advertised goods, contrary to paper dissemination which is manual and one way. Furthermore, this is contrary to dissemination through personal emails and social media which are personal and lack precise and consistent location context.

Previously, no interactive web-based residential-properties systems have existed, wherein content consumers, in the form of a group of people residing in a property, can be targeted, reached, and interacted with, through an abstracted entity that is residents-profile and property-location aware.

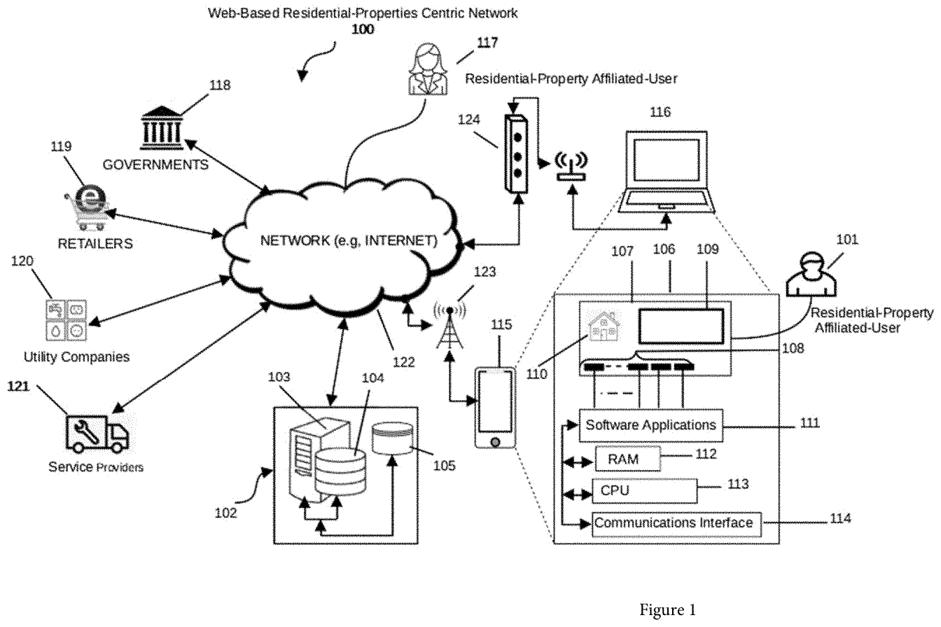

FIG. 1 illustrates web-based residential properties centric network 100 accessible by residential-property affiliated users 101. The network 100 includes a server 102, which may be implemented as a plurality of computers 103, each having storage 105 (electronic and/or magnetic and/or optical media storing instructions which when executed by the server 102 performs the functions described herein) and all connected to a residential properties database 104. The server 102 may be implemented in a cloud computing system having access to a wide-area network such as the Internet 122.

The user 101 may access the server 102 via the Internet 122 using a mobile device 115 or a desktop or laptop computer 116, each of which would have the configuration 106 of hardware and software shown, including a CPU 113, RAM 112, and communications interface 114, to access a residential property-associated webpage 107. The RAM 112 (and/or other computer-readable media) stores data and software applications 111 which when executed by the CPU 113 perform the steps described herein. The webpage 107 stores dashboard information 109 and street view image 110 of the residential property. In the case of either a computer 116 or mobile device 115, the communications interface 114 may include a display, keyboard, mouse, trackpad, touchscreen, microphone, speaker, etc. The computer 116 would be connected to the Internet 122 via a modem 124. The mobile device 115 would be connected to the Internet 122 via cell towers 123 (for example, but also via WiFi).

As shown in FIG. 1, additional residential-property affiliated users 117 would also be able to access the server 102 via the Internet 122. As will be explained in more detail below, government entities 118, retailers 119, utility companies 120, and service providers 121 all access the server 102 in different ways via the Internet 122.

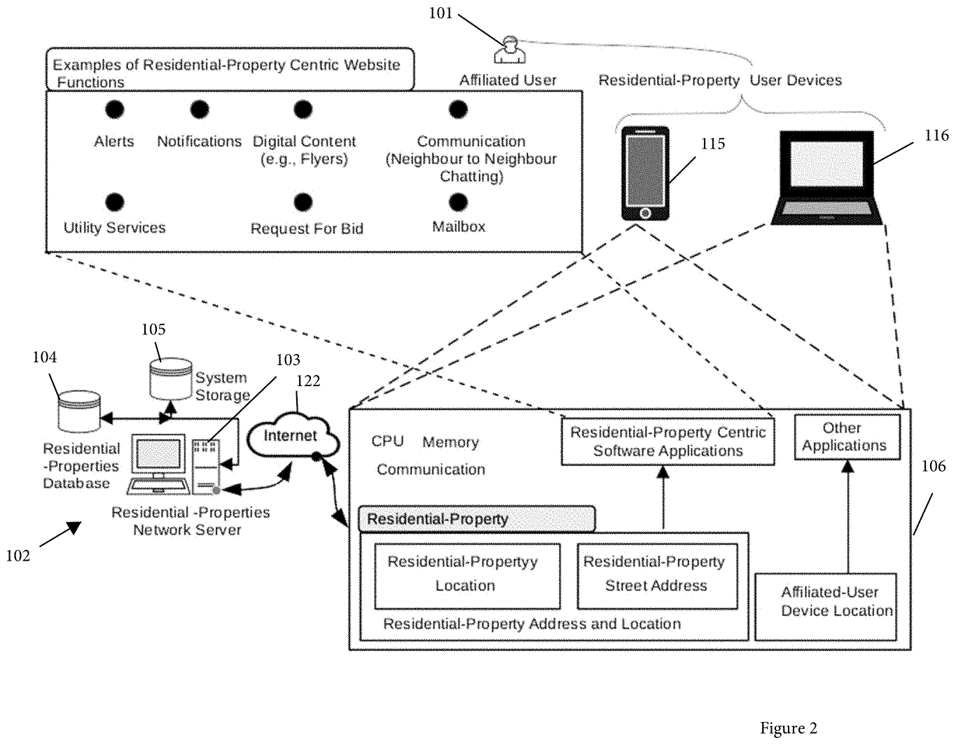

FIG. 2 illustrates a residential property affiliated user 101 interacting with the property website using a device 106 (115 or 116) that is connected to the residential-properties server 102, such as via a browser or dedicated app. The software applications 111 include residential-property centric software applications and other applications. The residential-property centric software applications include Alerts, Notifications, Digital Content (such as flyers), communication (such as neighbor-to-neighbor chatting), Utility Services, Request for Bid and Mailbox. The device 106 stores the residential property location (e.g. lat/long) as well as the residential property street address. The device 106 will also have stored a current device location (such as from GPS or cell tower triangulation), as is known.

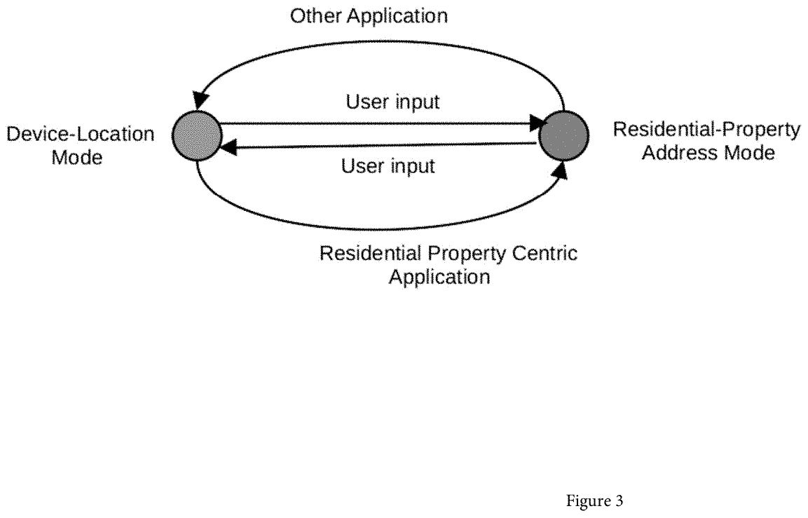

FIG. 3 illustrates how a device 106 switches to the residential-property mode based on detecting that the user is executing a residential-property centric software application. This causes the device ignore its current device location as computed by its onboard positioning and instead use the location from the Residential Properties Network database (i.e. a physical location of a residential property with which the user is associated). The user is also given the option to cause the device to switch to either mode. In device-location mode, applications on the device use the current device 106 location, as is known. In residential-property address mode, applications on the device use the location of the residential property.

For example, a search engine search on a browser may be provided with either the residential property location as the current location (to the extent the search engine uses location to tailor search results). As another example, ordering food or goods on ordering app (e.g. DoorDash, GrubHub, UberEats, etc) or website, the home address will be provided implicitly if you are on residential location mode. Furthermore, if the mode is not specified by the user explicitly, the invention will recognize/deduce the context via analyzing the interaction of the user with the other applications, knowledge about the application it can gather from other sources such as the internet, whether it is home address relevant or not, and use the right address. It will prompt the user to specify if it determines the other application may allow for either address as an interpretation.

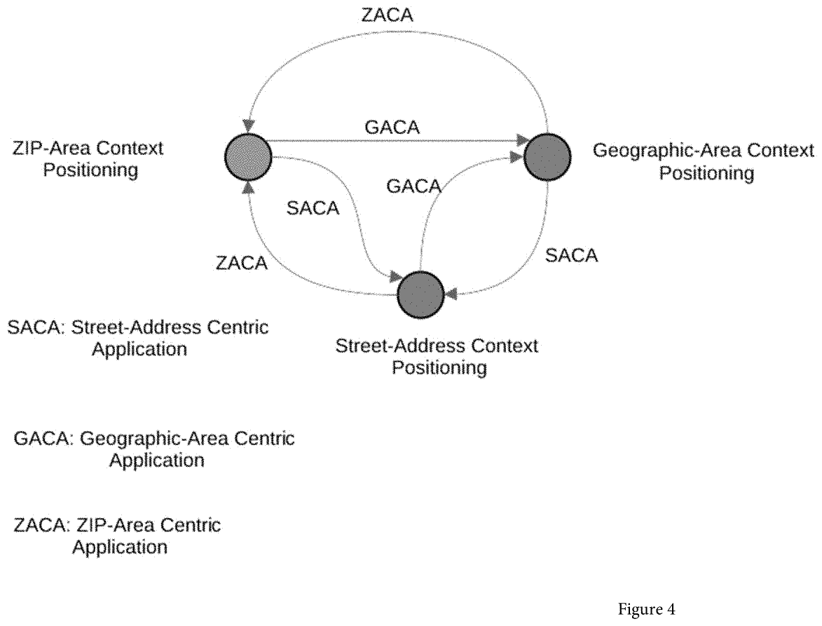

FIG. 4 illustrates three positioning sub-contexts the device has access to, namely street address position, Zip code position and geographic area position. Depending on the task the device 106 is executing in the residential-property mode, the appropriate sub-context will be activated.

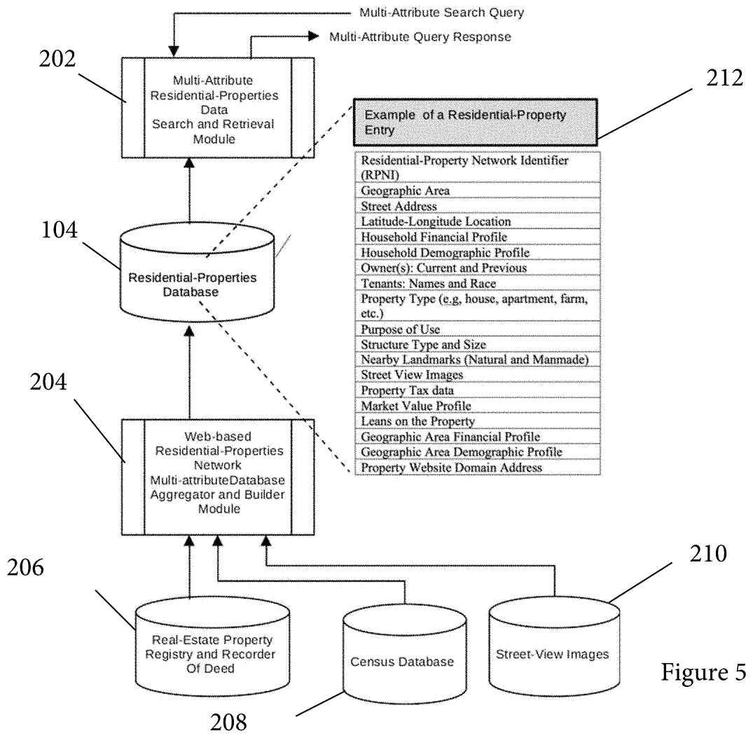

FIG. 5 illustrates an example of Residential-Properties Network Database 104 constructed from information extracted from three existing databases. This may be performed by the server 102. A web-based residential-properties multi-attribute database aggregator and builder module 204 searches and retrieves data relating to each property from one or more of: a real estate property registry and recorder of deeds 206, a census database 208, and street view images 210. Other databases could also be accessed. The figure provides an example of a property record 212 stored in the database 104 for each property. The property record 212 depicts attributes that can be used to search for properties in the database (single and multi-attributes), including one or more or all of the following:

Residential-Property Network Identifier (RPNI)

Geographic Area

Street Address

Latitude-Longitude Location

Household Financial Profile

Household Demographic Profile

Owner(s): Current and Previous

Tenants: Names and Race

Property Type (e.g. house, apartment, farm, etc.)

Purpose of Use

Structure Type and Size

Nearby Landmarks (Natural and Manmade)

Street View Images

Property Tax Data

Market Value Profile

Leans on the Property

Geographic Area Financial Profile

Geographic Area Demographic Profile

Property Website Domain Address

A multi-attribute residential properties data search and retrieval module 202 is programmed to receive multi-attribute search queries, access the database 104 and provide responses to the queries.

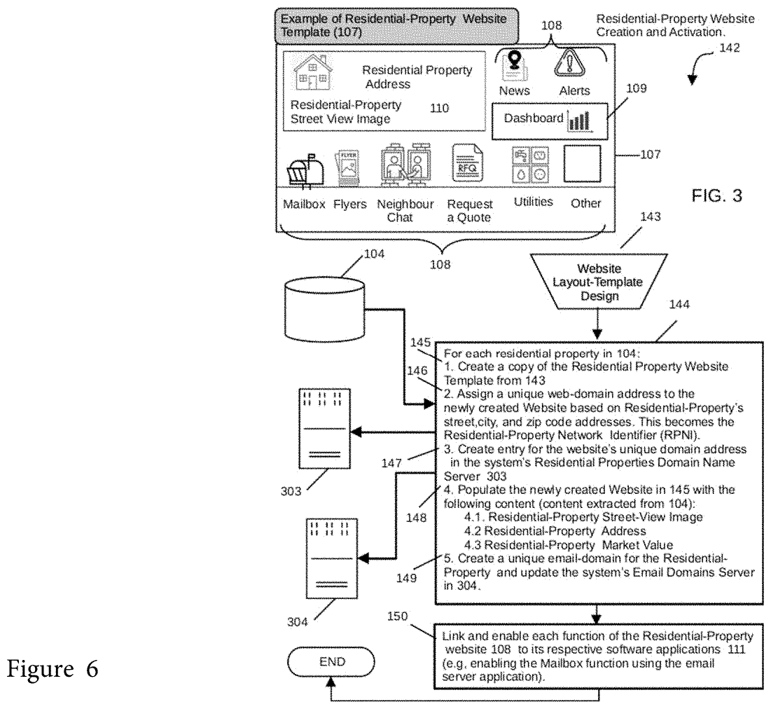

FIG. 6 illustrates the creation of a website for a given residential property. This may be performed in the server 102. A residential property website template 107 includes the street view image 110 of the property, icons 108 for residential property centric website functions, including news, alerts, mailbox, flyers, neighborhood chat, request a quote, utilities and other. The dashboard 109 is also provided in the template 107.

For each residential property in database 104, in step 143 the template 107 is retrieved. In step 145, a copy of the Residential Property Website Template 107 is created. In step 146, a unique web-domain address is assigned to the newly created Website based on Residential-Property's street, city, and zip code addresses. This becomes the Residential-Property Network Identifier (RPNI).

In step 147, an entry for the website's unique domain address is created in the system's Residential Properties Domain Name Server 303. In step 148, the newly created Website is populated with one or more or all of the following content extracted from database 104:

Residential-Property Street-View Image 110

Residential-Property Address

Residential-Property Market Value

Additional information may also be included.

In step 149, a unique email-domain for the Residential-Property created and the system's Email Domains Server 304 is updated.

In step 150, each function of the Residential-Property website 108 is linked to its respective software applications 111 and enabled (e.g. enabling to the Mailbox function using the email server application).

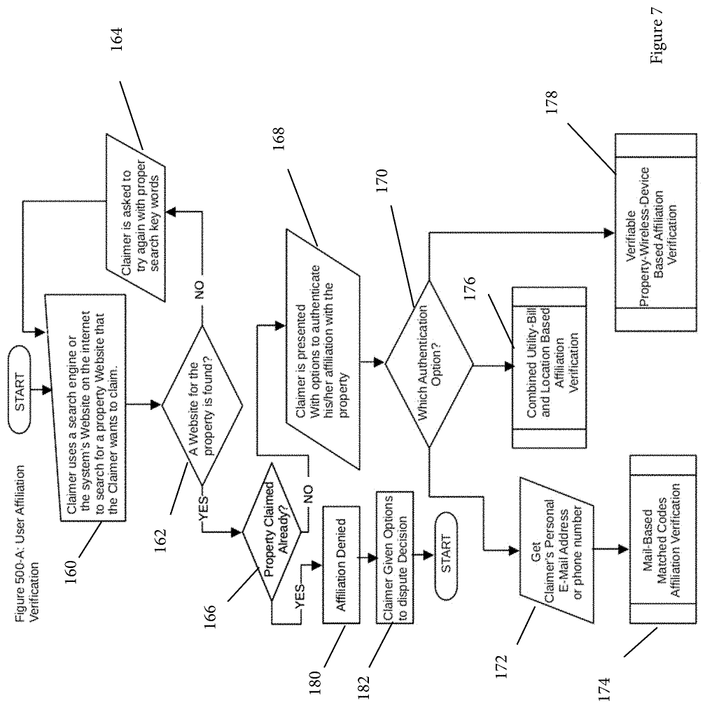

FIG. 7 illustrates the steps for performing property website claimer affiliation verification. The figure depicts the three affiliation verification options. In step 160, a person who wants to claim a residential property (“claimer”) uses a search engine or the system's Website on the internet to each for the property Website that the Claimer wants to claim. In step 162, it is determined whether a website for the property is found. If not, the claimer is asked to try again with proper search key words in step 164 and step 160 is repeated. If a website is found in step 162, then it is determined in step 166 if the property is claimed already. If not, then in step 168, the claimer is presented with options to authenticate his/her affiliation with the property. In step 170, the claimer is asked to choose an authentication option. Based upon the claimer's selection in step 170, in step 172 the server 102 may request claimer's personal email address and/or phone number, and then in step 174 the server 102 generates codes to send via mail and either email or telephone for the claimer to receive and enter on the website. Based upon the user's selection in step 170, the server 102 may combine utility-bill and location-based affiliation verification in step 176. Based upon the user's selection in step 170, the server 102 may use verifiable property-wireless-device based affiliation verification in step 178.

If the property is determined to have been already claimed in step 166, then affiliation is denied in step 180. In step 182, the claimer is given options to dispute this decision.

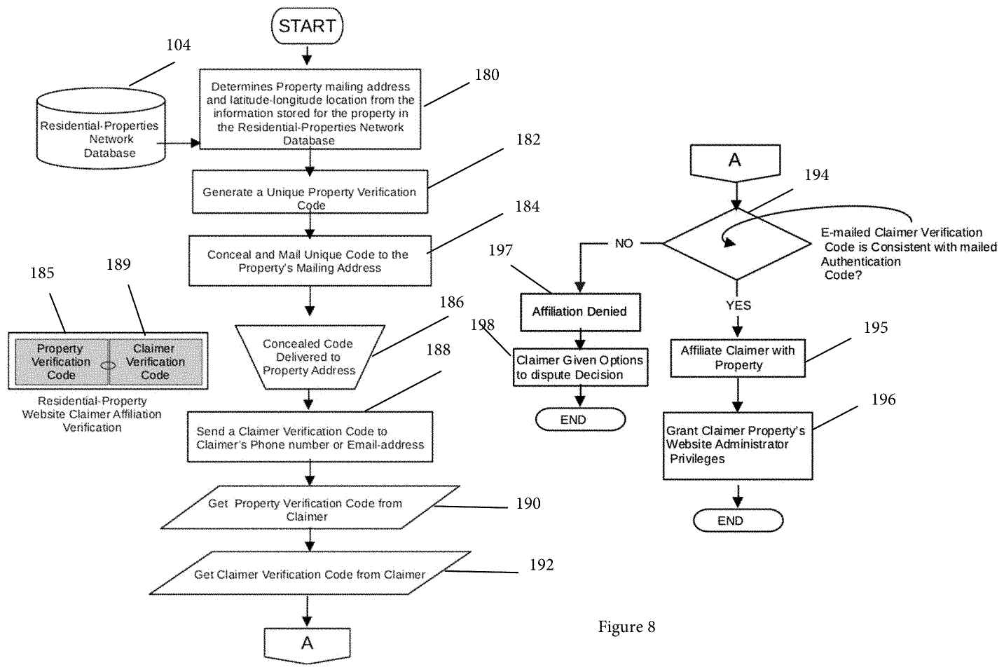

FIG. 8 illustrates in more detail step 174 of FIG. 7 for verifying the affiliation of a claimer to a residential-property website using a combination of code mailed to the property and another electronically communicated to the claimer. In step 180, the server 102 determines property mailing address and latitude-longitude location from the information stored for the property in the Residential-Properties Network Database 104. In step 182, the server 102 generates a unique property verification code 185 associated with the property. In step 184, a unique code is concealed and mailed to the property's mailing address. In step 186, the concealed code is delivered to the property address. In step 188, a claimer verification code 189 is sent to claimer's phone number or email address. In step 190, the property verification code 185 is obtained by the server 102 from claimer, such as on the website. In step 192, the claimer verification code 189 is obtained by the server 102 from the claimer, such as on the website. In step 194, it is determined whether the emailed claimer verification code is consistent with the mailed authentication code. If it is, then the claimer is affiliated with the property in step 195. The claimer is granted administrative privileges over the website affiliated with that property in step 196. If in step 194, it is determined that the codes are inconsistent, then affiliation is denied in step 197 and the claimer is given other options to dispute the decision in step 198.

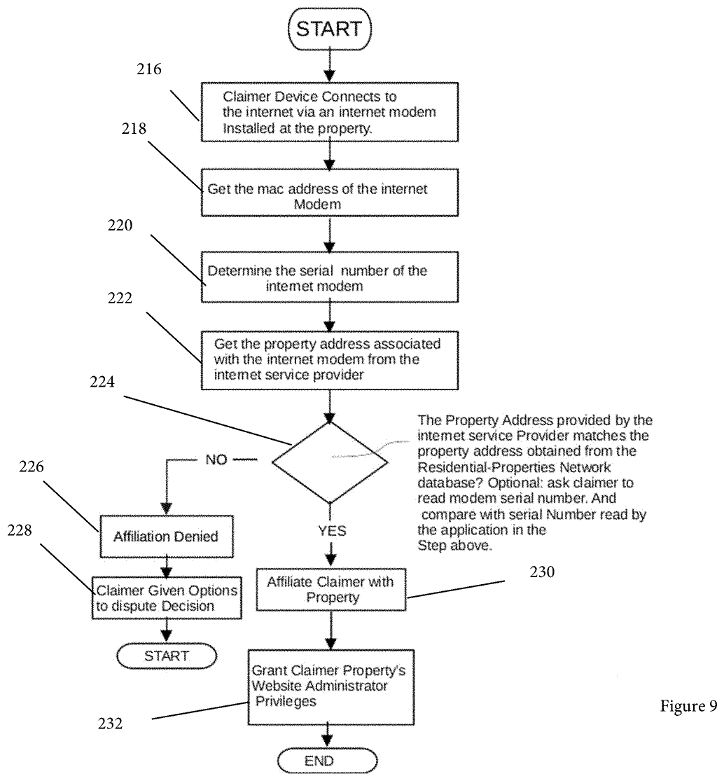

FIG. 9 illustrates the steps for verifying the affiliation of a claimer to a residential-property website using identification information of internet connected devices installed at the property, which is step 180 in FIG. 7. Referring to FIG. 9 and FIG. 1, in step 216 the claimer's device, such as mobile device 115 or computer 116, connects to the Internet 122 via an internet modem 124 installed at the property. The MAC address of the internet modem 124 is obtained in 218 by the server 102. The serial number of the internet modem 124 is obtained by the server 102 in step 220. The property address associated with the internet modem 124 is obtained by the server 102 from the internet service provider in step 222. In step 224 it is determined whether the property address provided by the internet service provider matches the property address obtained from the Residential-Properties Network database 104. Optionally, the server 102 could ask the claimer to read the modem 124 serial number and enter it on a webpage (for example), and then the server 102 would compare that modem 124 serial number with serial number read by the application in the step above.

If there is no match, then the affiliation is denied in step 226 and the claimer is given options to dispute the decision in step 228. If there is a match, then the server 102 affiliates the claimer with property in step 230 and grants the claimer administrator privileges over the property's website in step 232.

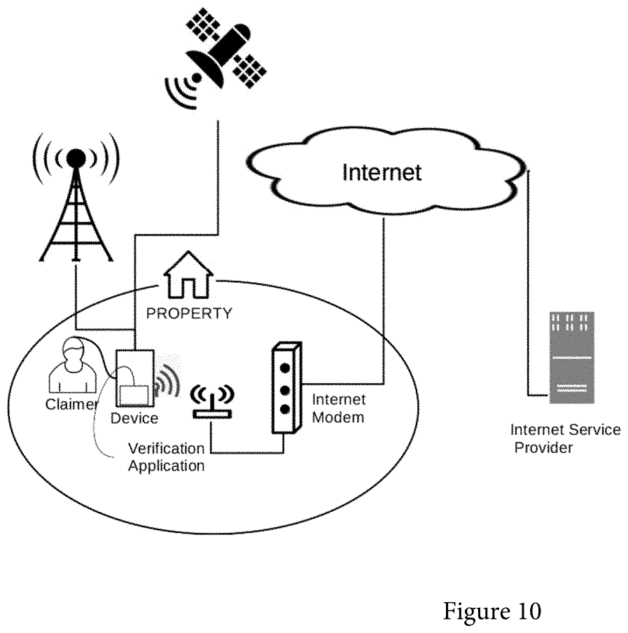

FIG. 10 illustrates an example of internet devices installed at the property that can be used in the affiliation verification process.

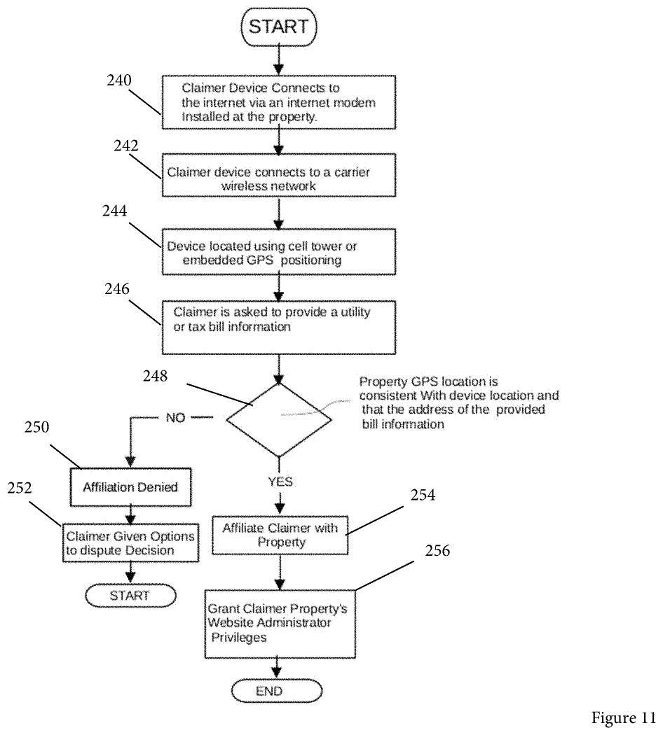

FIG. 11 illustrates the steps for verifying the affiliation of a claimer to a property website using utility bills and/or contracts, which is step 176 in FIG. 7. Referring to FIGS. 1 and 11, in step 240, the claimer device (such as mobile device 115 or computer 116) connects to the Internet 122 via an internet modem 124 installed at the property. In step 242, the claimer' s device 115, 116 connects to a carrier wireless network (e.g. cell data). In step 244, the device 115, 116 is located using cell tower or embedded GPS positioning. In step 246, the claimer is asked to provide a utility or tax bill information. In step 248, the server 102 determines whether the property GPS location is consistent with device location and the address of the provided bill information.

If not, then affiliation is denied in step 250 and the claimer is given options to dispute the decision in step 252. If it is consistent, then in step 254, the claimer is affiliated with the property and is granted administrator privileges over the property website.

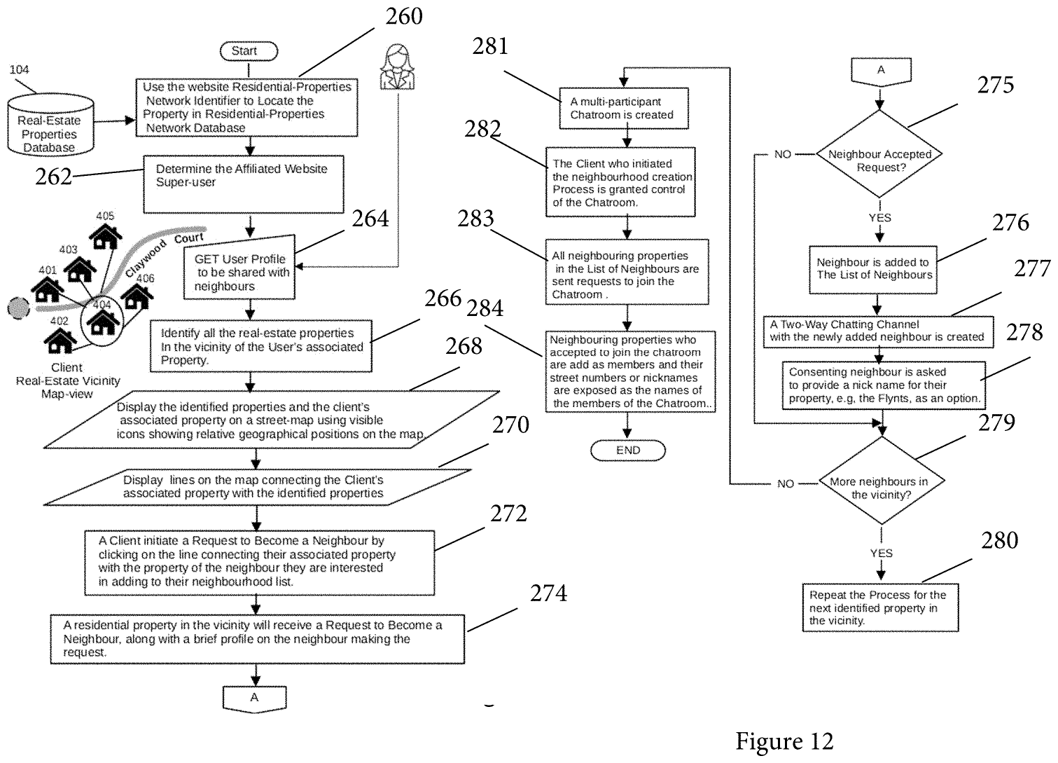

FIG. 12 illustrates the steps for enabling a property affiliated user to setup neighborhood (client means an affiliated property user). In step 260, the website Residential-Properties Network Identifier is used to Locate Property in Residential-Properties Network Database 104. In step 262, the Affiliated Website Super-user is determined. In step 264, the User Profile to be shared with neighbors is retrieved. In step 266, all the real-estate properties in the vicinity of the User's associated Property are identified.

In step 268, the identified properties and the client's associated property are displayed on a street-map using visible icons showing relative geographical positions on the map. In step 270, lines are displayed on the map connecting to the Client's associated property with the identified properties. In step 272, the client initiates a Request to Become a Neighbor by clicking on the line connecting their associated property with the property of the neighbor they are interested in adding to their neighborhood list. In response to step 272, a residential property in the vicinity will receive a Request to Become a Neighbor, along with a brief profile on the neighbor making the request.

In step 275, it is determined if the neighbor accepted the request. If so, the neighbor is added to The List of Neighbors in step 276 and a Two-Way Chatting Channel with the newly added neighbor is created in step 277. In step 278, a consenting neighbor is then asked to provide a nick name from their property, e.g. “the Flynts,” as an option. In step 279 it is then determined if there are more neighbors in the vicinity. If so, then in step 280, the process is repeated for the next identified property in the vicinity.

If there are no more neighbors in the vicinity, then a multi-participant chatroom is created in step 281. In step 282, the Client who initiated the neighborhood creation process is granted control of the chatroom. In step 283, all neighboring properties in the List of Neighbors are sent requests to join the Chatroom. In step 284, neighboring properties who accepted to join the chatroom are added as members and their street numbers or nicknames are exposed as the names of the members of the Chatroom.

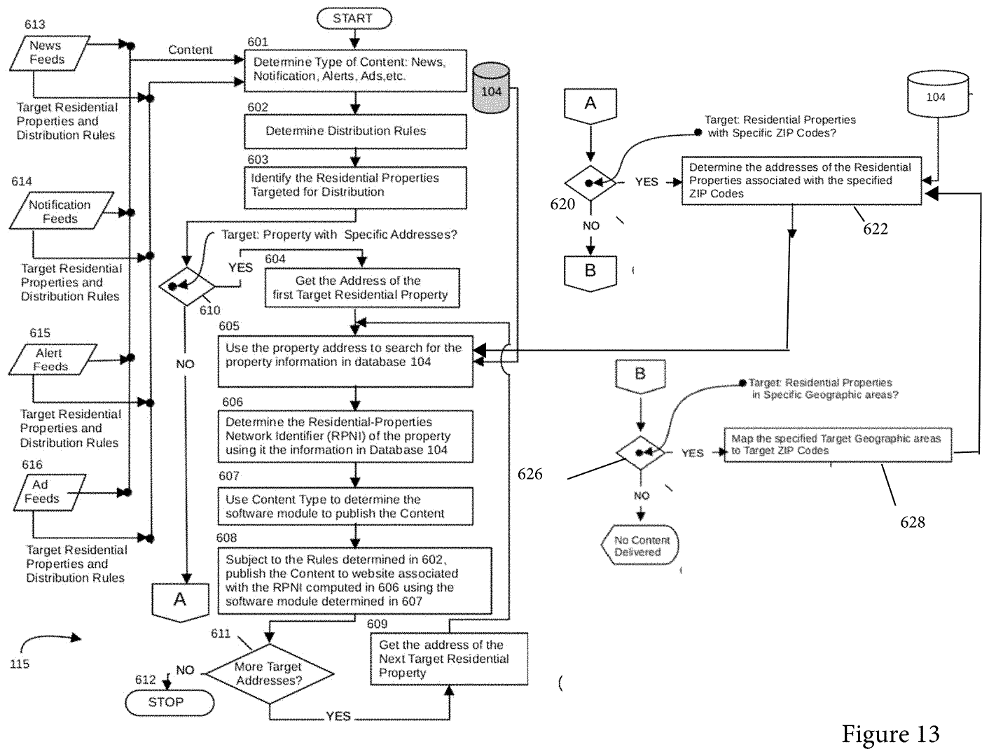

FIG. 13 illustrates the steps for distributing digital content such as alerts, notifications, and news based on rules specified by the source, including target locations. In step 601, the type of content: News, Notification, Alerts, Ads, etc., is determined. In step 602, the distribution rules are determined. In step 603, the Residential Properties Targeted for Distribution are identified. In step 610 it is determined if the target is property with Specific Addresses. If so, then in step 604, the Address of the first Target Residential Property is retrieved and the property address is used in step 605 to search for the property information in database 104. In step 606, the Residential-Properties Network Identifier (RPNI) of the property using it is determined in the information Database 104.

In step 607, the Content Type is used to determine the software module to publish the Content. In step 608, subject to the Rules determined in step 602, the Content is published to website associated with the RPNI computed in 606 using the software module determined in 607.

In step 611, it is determined if there are more targeted addresses. If so, then the address of the Next Target Residential Property is retrieved in step 609. If not, then the process is ended in step 612.

If in step 610 it was determined that the properties are not targeted with specific addresses, then it is next determined if the Residential Properties will be targeted based upon being associated with the specified ZIP Codes in step 620. If so, then the addresses of the Residential Properties associated with the specified ZIP Codes are determined in step 622. The process then continues to step 605, i.e. as if specific addresses had been targeted.

If the properties are not targeted based upon zip codes, then it is determined in step 626 if Residential Properties in Specific Geographic areas are targeted. If not, then no content is delivered. If so, then the specified Target Geographic areas are mapped to Target ZIP Codes in step 628 and then the process returns to step 622, i.e. as if zip codes had been targeted.

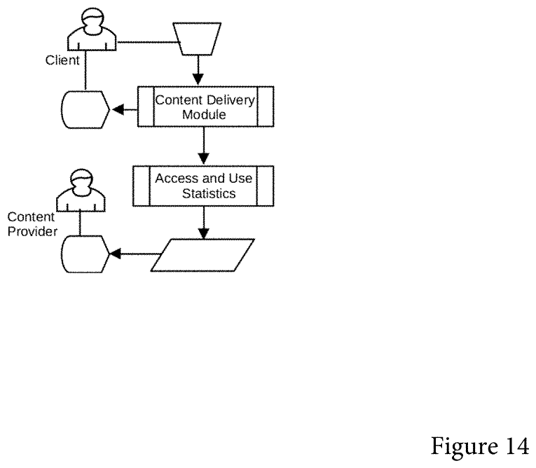

FIG. 14 illustrates the steps for generating access and use reports to be shared with content sources. Because digital content is associated with physical addresses and digital content is distributed to digital representation of these physical addresses, the server 102 determines physical location based statistics of readership and browsing rates and frequencies, stats on location-based time of browsing, what specific part of the content had more interest and in what locations, and compares these statistics between zipcodes and geographical areas. Because households are allowed to act on the digital flyer to initiate a transaction to buy an advertised good, the conversion rates can be deduced and associated to specific households, streets, zipcodes, etc. This information is shared with retailers (content suppliers) so they can optimize their reach out and product stocking.

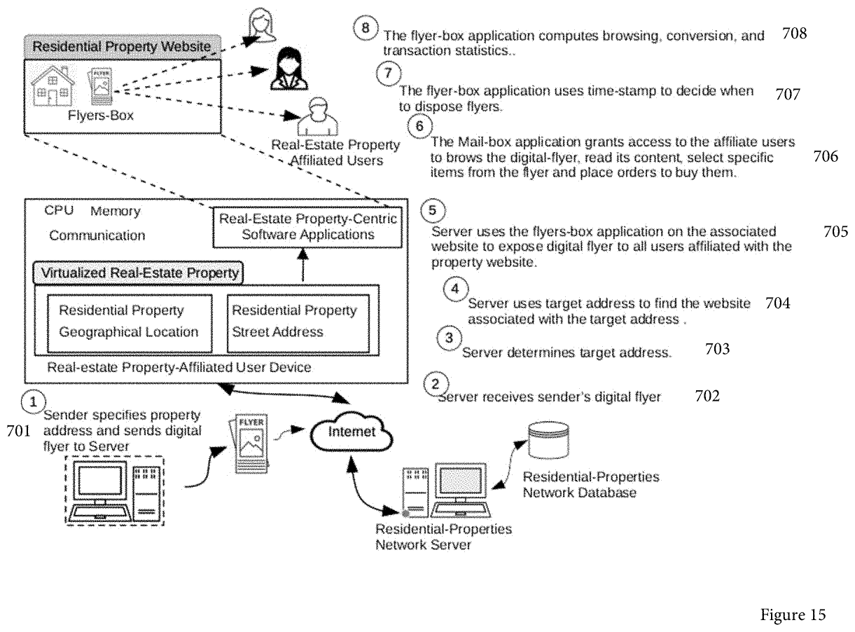

FIG. 15 illustrates an example of distributing digital flyers to particular households based on location and other rules specified by the source of the flyers. In step 701, the sender specifies property address and sends digital flyer to server 102.

In step 702, the server 102 receives sender's digital flyer. The server 102 determines target address in step 703. In step 704, the server 102 uses target address to find the website associated with the target address.

In step 705, the server 102 uses the flyers-box application on the associated website to expose digital flyer to all users affiliated with the property website.

In step 706, the Mail-box application grants access to the affiliate users to browse the digital-flyer, read its content, select specified items from the flyer and place orders to buy them.

In step 707, the flyer-box application uses time-stamp to decide when to dispose of the flyers.

In step 708, the flyer-box application computes browsing, conversion, and transaction statistics.

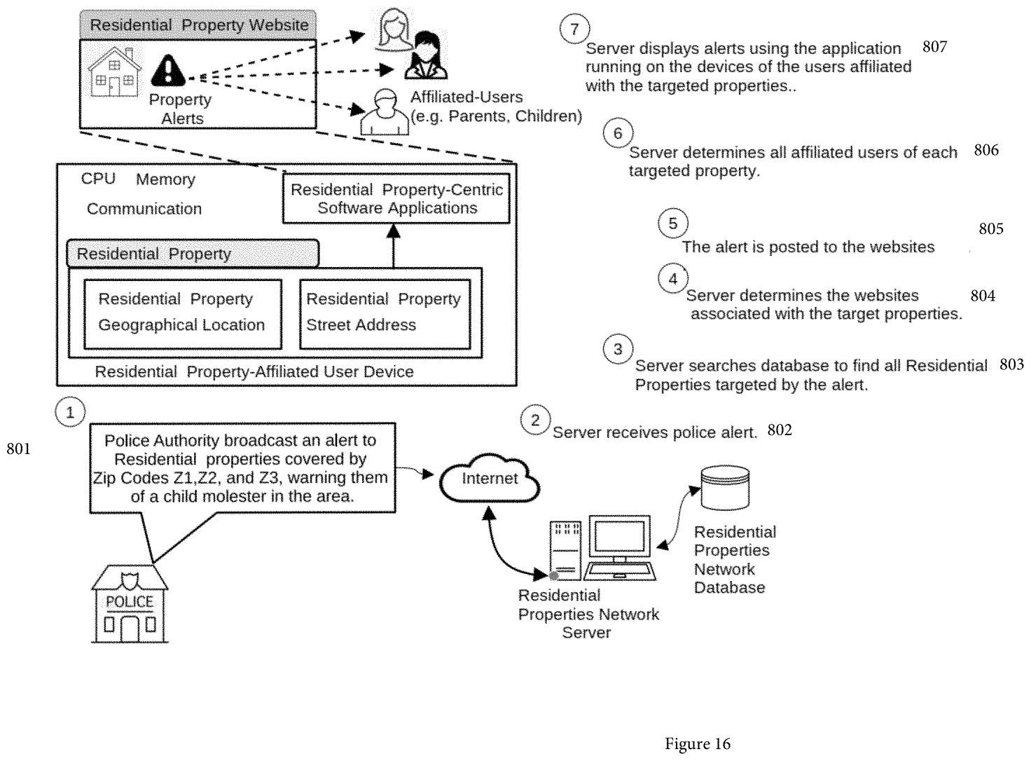

FIG. 16 illustrates an example of police digital alerts distribution to targeted residential properties. In step 801, the Police Authority broadcasts an alert to Residential properties covered by Zip Codes Z1, Z2, and Z3, warning them of a child molester or other danger in the area.

In step 802, the server 102 receives police alert. In step 803, the server 102 searches database 104 to find all Residential Properties targeted by the alert. In step 804, the server 102 determines the websites associated with the targeted properties. In step 805, the alert is posted to the websites that were found in step 804.

In step 806, the server 102 determines all affiliated users of each targeted property (e.g. the super user or admin, plus an affiliated users given access by the super user).

In step 807, the server 102 displays alerts using the application running on the devices of the users affiliated with the targeted properties.

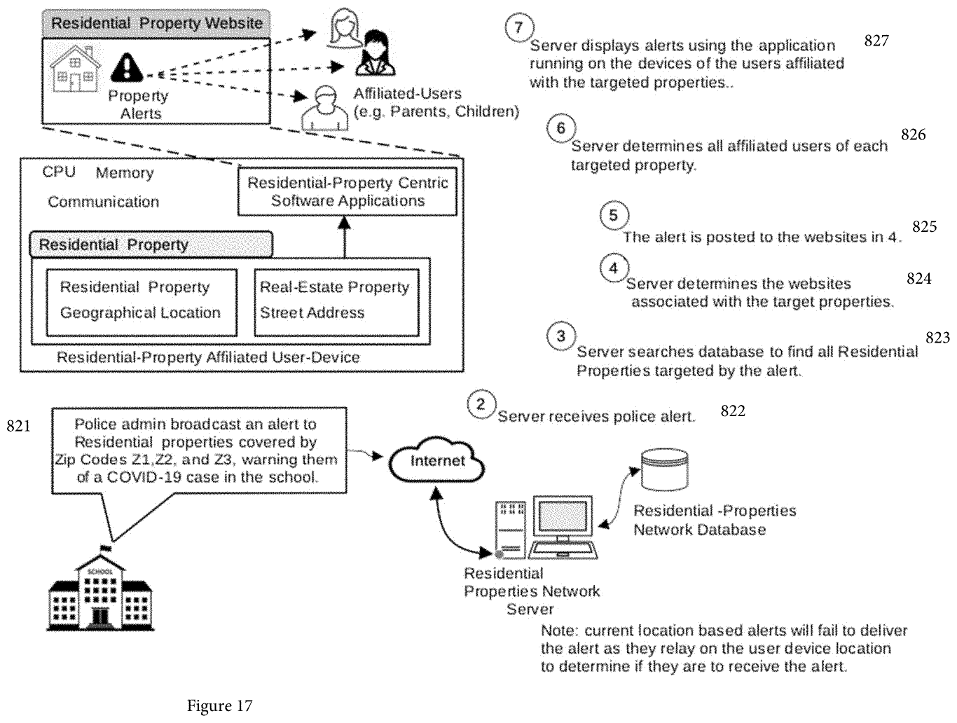

FIG. 17 illustrates an example of school digital alerts distribution to targeted residential properties. In step 821, Police admin broadcast an alert to Residential properties covered by Zip Codes Z1, Z2, and Z3, warning them of a COVID-19 case or other health outbreak in the school. In step 822, the server 102 receives the police alert. In step 823, the server searches the database 104 to find all Residential Properties targeted by the alert. In step 824, the server 102 determines the websites associated with the target properties. In step 825, the alert is posted to the websites found in step 824. In step 826, the server 102 determines all affiliated users of each targeted property. In step 827, the server 102 displays alerts using the application running on the devices of the users affiliated with the targeted properties.

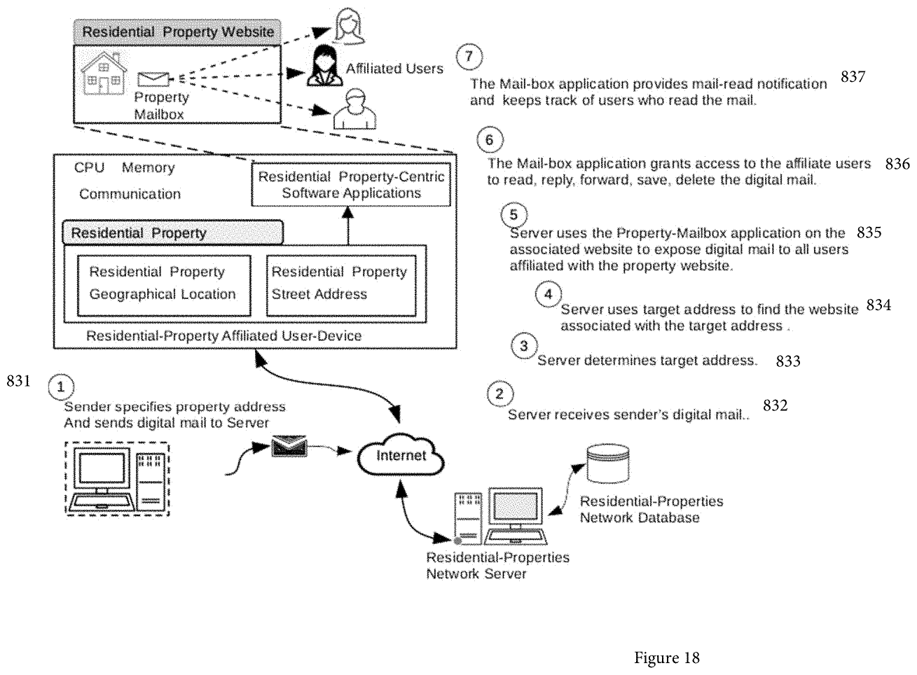

FIG. 18 illustrates an example of a virtual property mailbox, and the steps for delivering digital mail targeted to the virtual-mailbox of the real-state property. In step 831, the sender specifies property addresses and sends digital mail to the server 102. In step 832, the server 102 receives the sender's digital mail. In step 833, the server 102 determines the target address. In step 834, the server 102 uses target address to find the website associated with the target address. In step 835, the server 102 uses the property mailbox application on the associated website to expose digital mail to all users affiliated with the property website. In step 836, the mailbox application grants access to the affiliate users to read, reply, forward, save, delete the digital mail. In step 837, the mailbox application provides mail read notification and keeps track of users who read the mail.

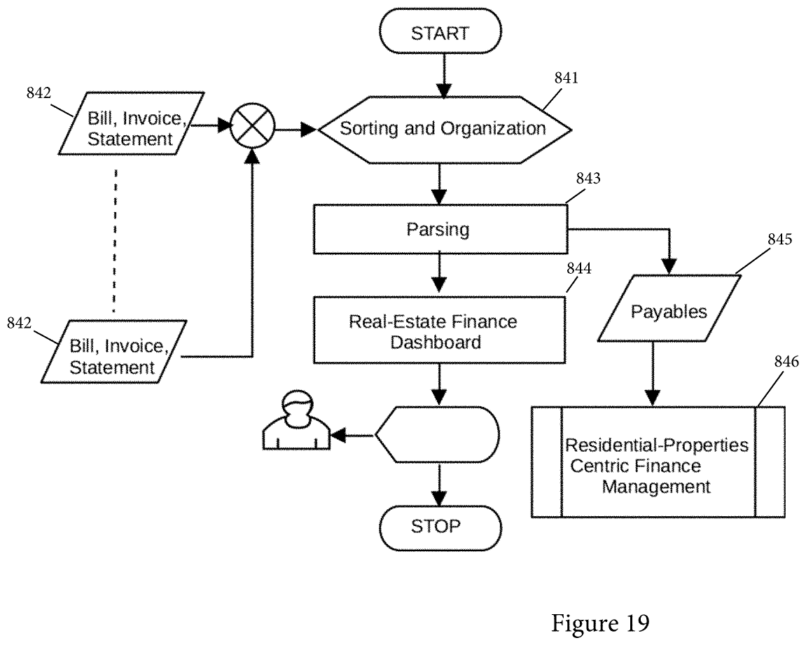

FIG. 19 illustrates a method for sorting and paying for bills and a dashboard to display to the user a detailed financial integrated report on payables and up-to-date expenses. In step 841, the bills, invoices and statements 842 are sorted and organized. They are then parsed in step 843 and sent to the real estate finance dashboard 844. The payables 845 are sent to residential properties centric finance management 846.

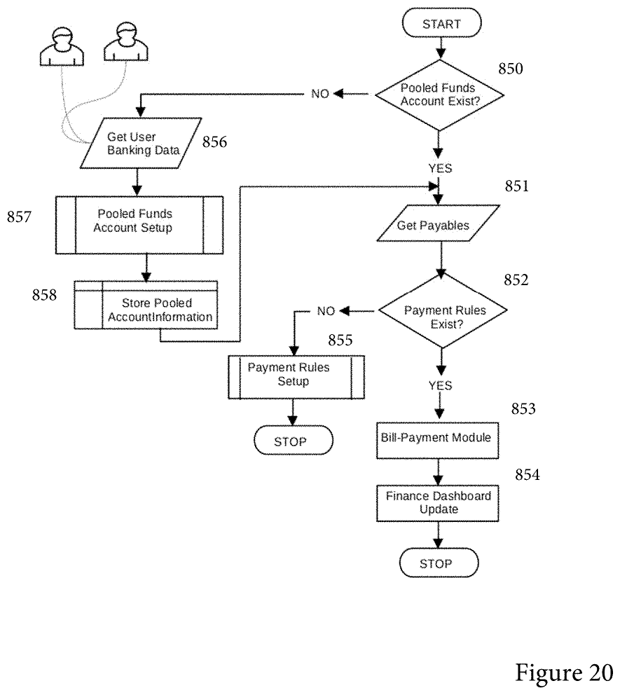

FIG. 20 illustrates the steps of settling payables and for setting up a pooled Funds account for the users affiliated users. In step 850, it is determined if a pooled funds account exists. If so, then the payables are retrieved in step 851. If a pooled funds account does not exist, then user banking data is obtained in step 856 and a pooled funds account is set up in step 857. The pooled account information is stored in step 858.

Once a pooled funds account exists, then payables are retrieved in step 851. In step 852, it is determined whether payment rules exist. If so, the process proceeds to the bill payment module 853. The finance dashboard is updated in step 854. If payment rules did not exist in step 852, they are set up in step 855.

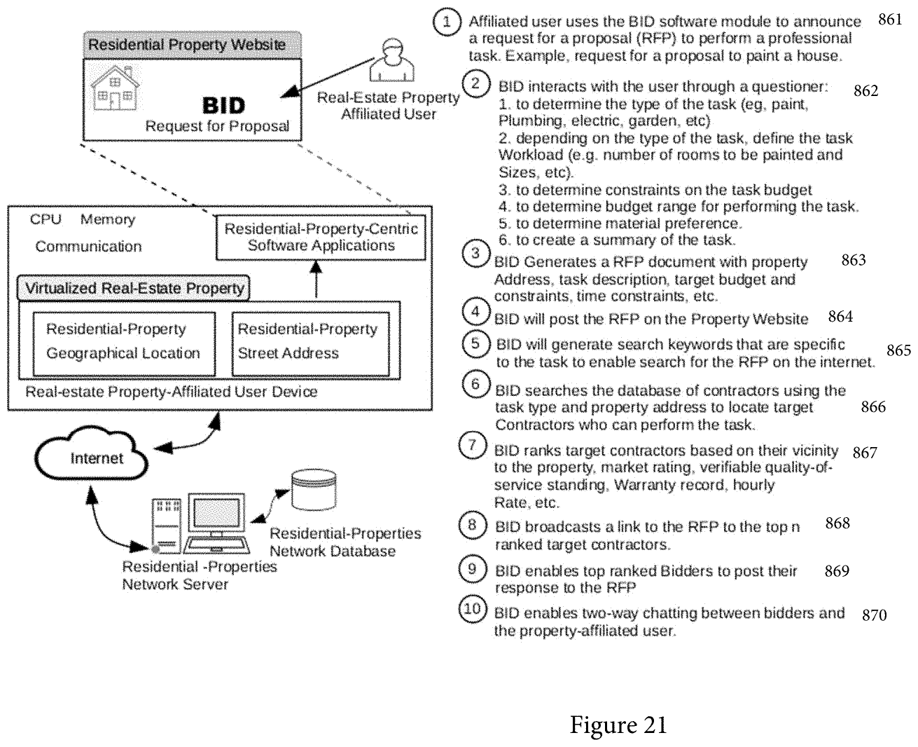

FIG. 21 illustrates the steps for an affiliated property user to advertise, on the property website, request for bid to perform work at the property, such as painting, electric, lawnmowing, etc. in step 861, an affiliated user uses the BID software module (in server 102) to announce a request for a proposal (RFP) to perform a professional task. For example, the user may request a proposal to paint a house.

In step 862, BID interacts with the user through a questioner:

To determine the type of task (e.g. paint, Plumbing, electric, garden, etc)

Depending on the type of the task, define the task Workload (e.g. number of rooms to be painted and Sizes, etc.)

To determine constraints on the task budget

To determine budget range for performing the task

To determine material preference

To create a summary of the task

In step 863, based upon the information from step 862, BID Generates a RFP document with property Address, task description, target budget and constraints, time constraints, etc.

In step 864, BID will post the RFP on the Property Website. In step 865, BID will generate search keywords that are specific to the task to enable search for the RFP on the internet 122. In step 866, BID searches the database of contractors using the task type and property address to locate target Contractors who can perform the task.

In step 867, BID ranks target contractors based on their vicinity to the property, market rating, verifiable quality-of service standing, Warranty record, hourly Rate, etc.

In step 868, BID broadcasts a link to the RFP to the top in ranked target contractors. In step 869, BID enables top ranked Bidders to post their response to the RFP. In step 870, BID enables two-way chatting between bidders and the property-affiliated user.

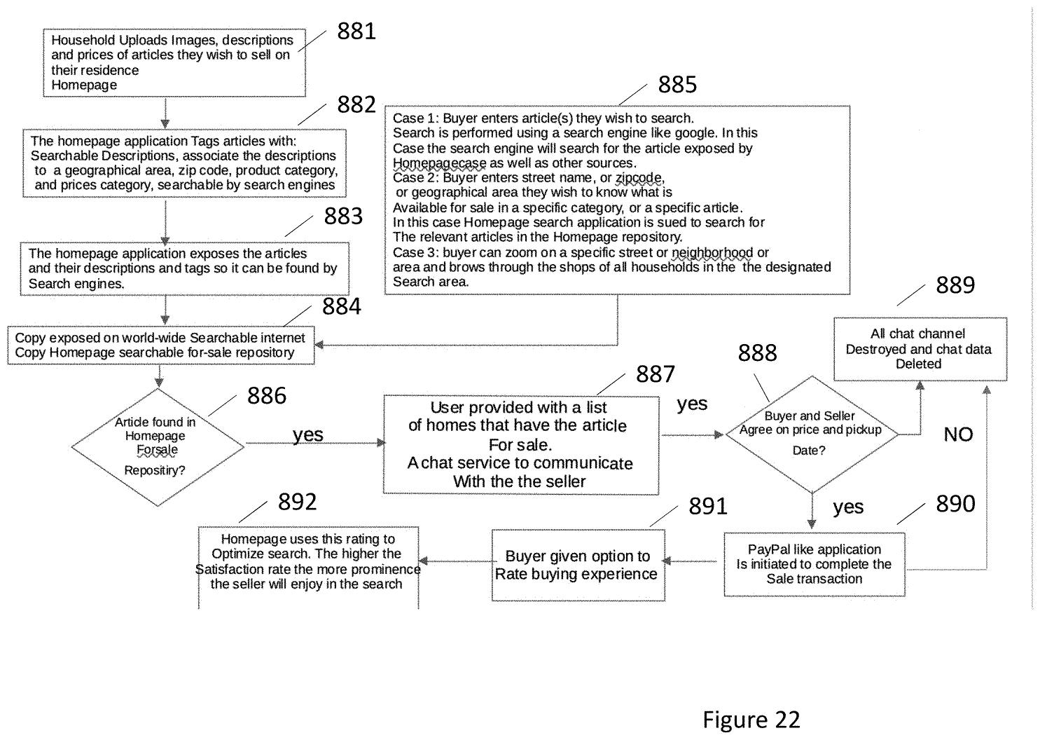

FIG. 22 is a flowchart illustrating the method of a property-affiliated user offering items for sale over the network of FIG. 1. In step 881 a member of the household uploads Images, descriptions, and prices of articles they wish to sell on their residence homepage. In step 882, the homepage application or server 102 tags articles with searchable descriptions, associate the descriptions to a geographic area, zip code, product category, and prices category and makes all of this searchable by search engines.

In step 883, the homepage application exposes the articles and their descriptions and tags so it can be found by search engines. In step 884, a copy is exposed on world-wide searchable Internet 122 and a copy is on the homepage network searchable for-sale repository. Three examples of ways to implement step 885 are given in FIG. 22. In case 1, a buyer enters article(s) they wish to search and a search is performed using a search engine like google. In this case the search engine will search for the article exposed by Homepagecase as well as other sources.

In case 2, a buyer goes to the Homepage network of FIG. 1 (via a browser or via an app on a mobile device) and enters a street name or zip code or geographic area where they wish to know what is available for sale. The buyer can search a particular category of items or for a particular article. In this case the Homepage search application is used to search for the relevant articles in the Homepage repository.

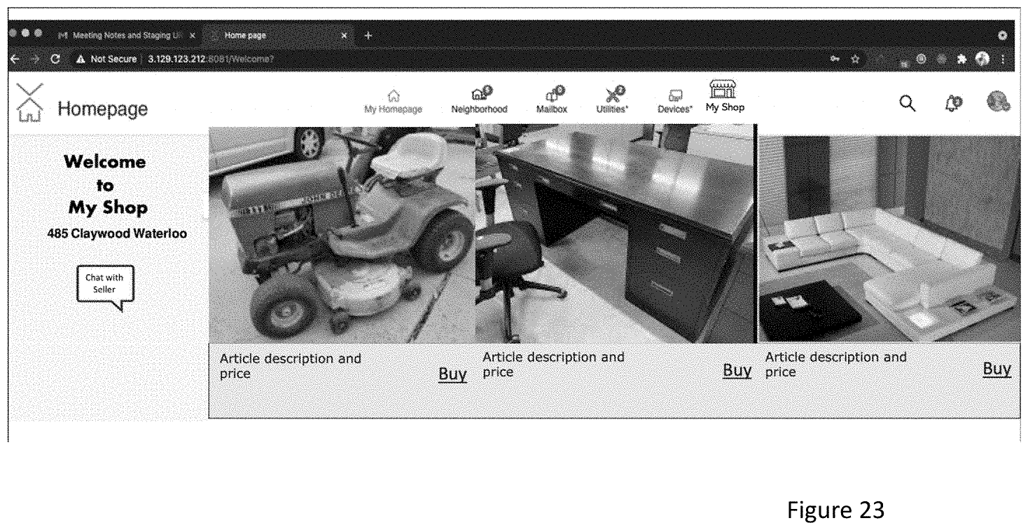

In case 3, the buyer again goes to the Homepage network of FIG. 1 (via a browser or via an app on a mobile device) and can zoom on a specific street or area and browse through the shops of all households in the designated search area, similar to a virtual neighborhood garage sale. An example webpage is shown in FIG. 23, where pictures of the articles offered for sale by a particular household are displayed, along with text of the article description and price, a “buy” link, and a link to initiate a chat with the seller.

If an article is found in step 886 based upon any of the searches from step 885, the user is provided with a list of homes that have the article for sale. A chat service to communicate with the seller may be initiated.

If the buyer and seller do not agree on a price and pickup date in step 888, then all of their chat is deleted in step 889. If the buyer and seller agree on a price and pickup date in step 888, then payment is arranged through the server 102 to complete the sale transaction in step 890. Post-sale, all of their chat is deleted in step 889 and the buyer is given an option to rate the buying experience based upon that transaction in step 891 The server 102 uses this rating to optimize future searches, with high-rated sellers achieving higher prominence in the search results in step 892. After step 889, the buyer can no longer chat with the seller household.

The system also connects the website to residential apparatuses such as sensors, actuators and appliances that are installed at the property. Affiliated users are able to monitor and operate these apparatuses through the property website, manually, or automatically, taking advantage of interfacing protocols provided by the original apparatuses manufactures. Furthermore, the method enables the user to set up operation modes of the apparatuses based on the relative location of the user and the property location. For example, the operation of a garage door is performed such that the garage door closes as soon as the user leaves the property by comparing the location of the user, inferred form a device the user is carrying, with the property location. Or open the garage door when the method detects that the user is approaching the property. Similarly, various economical, security and safety rules can be setup to regulate the operation of devices installed at the property. The method allows the user to setup rules for controlling these devices. The method uses communication protocols such as MQTT to interact with the devices in a secure manner.

The inhabitants' personal digital information is separated from the digital information that is specific to the property they inhabit. The method provides for a function to enable information sharing among the affiliated inhabitants in accordance with access and sharing rules defined by the property affiliated super-user. The method provides a dashboard for displaying summaries of the information. For example, the dashboard displays monthly phone expenses, hydro expenses, rent expenses, maintenance expenses, etc. The method parses the content to extract relevant information to be displayed on the dashboard.

The method provides a method for archiving transferable property related content, such as important contracts, warranties, designs, plans (architectural, electrical, mechanical, etc.). The sales transaction will trigger a transfer of the homepage entity to the new owner (or new tenant) and all information the prior owner stored in the transferable data folder.

The system provides for a method for managing the transfer of a property website to new affiliated users (e.g., new property owners, new tenants, etc.). The method facilitates the removal of the information created by the prior affiliated inhabitants of the property, or information they have received and stored in the website of the property. The method enables the transfer and storage of this information to an electronic storage medium for future access and use by the prior affiliated inhabitants. The method enables the transfer of existing property related information, such as important contracts, warranties, designs, plans (architectural, electrical, mechanical, etc.), to the new inhabitants.

The residence entity may contain digital content that is relevant for the new owner: warranty documents, plans, service contracts, manuals, instructions, FYI kind of information, etc. The sales transaction will trigger a transfer of the homepage entity to the new owner (or new tenant) and all information the prior owner stored in the transferable data folder.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A method for operating a network on at least one computer including:
a) creating and hosting a plurality of websites each associated with each of a plurality of residential properties;
b) associating information regarding each of the plurality of residential properties with each of the plurality of websites;
c) verifying each of a plurality of users as a resident of each of the plurality of residential properties; and
d) based upon said step c), granting each of the plurality of users administrative privileges over the website associated with the residential property associated with said each user.

2. The method of claim 1 further including:
e) receiving from one of the plurality of users a designation of an additional user as an additional resident of an associated one of the plurality of residential properties; and
f) based upon said step e), granting access to the associated website to the additional user.

3. The method of claim 1 further including:
e) receiving a designation of a targeting group of the plurality of residential properties; and
f) based upon said step e), distributing information to the targeted group of the plurality of residential properties.

4. The method of claim 3 wherein the designation in step e) is a zip code.

5. The method of claim 4 further including finding street addresses of the targeted group of the plurality of residential properties, and wherein said step f) is performed based upon the street addresses of the targeted group of the plurality of residential properties.

6. The method of claim 1 further including receiving a request from a requesting user of the plurality of users to invite users associated with residential properties proximate the residential property of the requesting user to be associated as neighbors in the network.

7. The method of claim 6 further including the step of receiving an acceptance from the users associated with residential properties proximate the residential property of the requesting user, and in response, creating a neighbors chatroom.

8. The method of claim 1 further including the step of using a physical location of one of the plurality of residential properties as a current location of a device of the user associated with the one of the plurality of residential properties wherein the physical location of the one of the plurality of residential properties is different from an actual current location of the device.

9. The method of claim 1 further including:
e) receiving from one of the plurality of users information regarding at least one item for sale; and
f) in response to said step e), adding the information regarding the at least one item for sale to the website associated with the residential property associated with the one of the plurality of users.

10. The method of claim 9 further including:
g) receiving a request from a buyer to search for items to purchase; and
h) in response to step g), providing the website associated with the one of the plurality of users to the buyer.

11. The method of claim 10 wherein said step g) further includes receiving a street name.

12. The method of claim 10 wherein said step g) includes receiving a request to browse a subset of the plurality of websites that are in a specified geographic region and have items for sale.

13. The method of claim 10 further including: after step h), providing communication between the buyer and the one of the plurality of users.

14. The method of claim 13 further including:
i) facilitating payment between the buyer and the one of the plurality of users for purchase of the item; and
j) after said step i), deleting communications between the buyer and the one of the plurality of users.

15. The method of claim 1 wherein said step c) includes:
mailing a mailed code to a first residential property of the plurality of residential properties;
electronically providing an electronic code to a first user of the plurality of users;
receiving the mailed code and the electronic code; and
verifying that the mailed code is consistent with the electronic code.

16. The method of claim 1 wherein said step c) includes:
obtaining a mac address of an internet modem of a first user of the plurality of users; and
obtaining a property address based upon the mac address.

17. The method of claim 1 wherein said step c) includes:
e) locating a wireless mobile device using cell tower triangulation or a GPS receiver on the wireless mobile device;
f) receiving utility bill or tax bill information associated with a first property of the plurality of residential properties; and
g) determining whether the location obtained in step e) is consistent with address information on the utility bill or tax bill information received in step f).

18. Computer-readable, non-transitory storage media embodying software which when executed by at least one processor performs the following processes:
a) creating and hosting a plurality of websites each associated with each of a plurality of residential properties;
b) associating information regarding each of the plurality of residential properties with each of the plurality of websites;
c) verifying each of a plurality of users as a resident of each of the plurality of residential properties; and
d) based upon said step c), granting each of the plurality of users administrative privileges over the website associated with the residential property associated with said each user.

19. A system comprising at least one processor and memory coupled to the at least one processor including instructions which when executed by the at least one processor perform the following operations:
a) creating and hosting a plurality of websites each associated with each of a plurality of residential properties;
b) associating information regarding each of the plurality of residential properties with each of the plurality of websites;
c) verifying each of a plurality of users as a resident of each of the plurality of residential properties; and
d) based upon said step c), granting each of the plurality of users administrative privileges over the website associated with the residential property associated with said each user.
